(19) United States
(12) Patent Application Publication
(10) Pub. No.: US 2013/0147810 A1
(43) Pub. Date: Jun. 13, 2013

(54) APPARATUS RESPONSIVE TO AT LEAST ZOOM-IN USER INPUT, A METHOD AND A COMPUTER PROGRAM

(71) Applicant: Olcay Guldogan, Tampere (FI)

(72) Inventor: Olcay Guldogan, Tampere (FI)

(73) Assignee: NOKIA CORPORATION, Espoo (FI)

(21) Appl. No.: 13/313,587

(22) Filed: Dec. 7, 2011

(51) Int. Cl. G06T 13/00

(52) U.S. Cl. 345/473

(57) ABSTRACT

A method, apparatus, computer program and user interface wherein the method comprises displaying a still image on a display; detecting user selection of a portion of the still image; and in response to the detection of the user selection, replacing the selected portion of the image with a moving image and maintaining the rest of the still image, which has not been selected, as a still image.

### TECHNOLOGICAL FIELD

Embodiments relate to a method, apparatus, computer program and user interface. In particular, they relate to a method, apparatus, computer program and user interface which enable a user to view images.

### BACKGROUND

Apparatus which enable a user to view images are known. It would be useful to provide an improved or alternative way of enabling a user to view images and control the images which are displayed on a display.

### BRIEF SUMMARY

According to various, but not necessarily all, embodiments there is provided a method comprising: displaying a still image on a display; detecting user selection of a portion of the still image; and in response to the detection of the user selection, replacing the selected portion of the still image with a moving image and maintaining the rest of the still image, which has not been selected, as a still image.

In some embodiments the moving images may be displayed within the still image so that there is no discontinuity between the boundary of the moving images and the boundary of the still image.

In some embodiments the moving images may be located within any portion of the still image

In some embodiments the still image may comprise motion portions and non-motion portions such that in response to the detection of user selection of a motion portion the selected motion portion is replaced with a moving portion and in response to the detection of user selection of a non-motion portion the whole of the still image is maintained as a still image.

In some embodiments the method may further comprise, in response to the detection of user selection of a second portion of the still image, replacing the second selected portion of the still image with a second moving image and maintaining the rest of the still image, which has not been selected, as a still image. The first portion and the second portion may be selected simultaneously so that a plurality of selected portions of the still image may be replaced with moving images simultaneously.

In some embodiments the still image may be one of a plurality of images displayed simultaneously on the display.

In some embodiments maintaining the non-selected portion of the still image as a still image may comprise making no change to the non-selected portion of the still image.

In some embodiments the still image may comprise a photograph. The moving images may comprise portions of a plurality of photographs captured in temporal proximity to the still image.

In some embodiments a portion of the still image may be selected by actuating the area of the display in which the portion of the still image is displayed.

According to various, but not necessarily all, embodiments there is provided a at least one processor; and at least one memory including computer program code; wherein the at least one memory and the computer program code are configured to, with the at least one processor, enable the apparatus to: display a still image on a display; detect user selection of a portion of the still image; and in response to the detection of the user selection, replace the selected portion of the still image with a moving image and maintain the rest of the still image, which has not been selected, as a still image.

In some embodiments the moving images may be displayed within the still image so that there is no discontinuity between the boundary of the moving images and the boundary of the still image.

In some embodiments the moving images may be located within any portion of the still image.

In some embodiments the image may comprise comprises motion portions and non-motion portions such that in response to the detection of user selection of a motion portion the at least one memory and the computer program code are configured to, with the at least one processor, enable the apparatus to replace the selected motion portion with a moving portion and in response to the detection of user selection of a non-motion portion maintain the whole still image as a still image.

In some embodiments the at least one memory and the computer program code may be configured to, with the at least one processor, enable the apparatus to detect user selection of a second portion of the still image and in response to the detection of user selection of the second portion of the still image, replace the second selected portion of the still image with a second moving still image and maintain the rest of the still image, which has not been selected, as a still image.

In some embodiments the first portion and the second portion may be configured so that they may be selected simultaneously so that a plurality of selected portions of the still image are replaced with moving portions simultaneously.

In some embodiments the still image may be one of a plurality of images displayed simultaneously on the display.

In some embodiments maintaining the non-selected portion of the image as a still image may comprise making no change to the non-selected portion of the still image.

In some embodiments the still image may comprise a photograph. In some embodiments moving images may comprise portions of a plurality of photographs captured in temporal proximity to the still image.

In some embodiments a portion of the image may be selected by actuating the area of the display in which the portion of the image is displayed.

According to various, but not necessarily all, embodiments there is provided an apparatus comprising: means for displaying a still image on a display; means for detecting user selection of a portion of the still image; and means for replacing, in response to the detection of the user selection, the selected portion of the still image with a moving image and maintaining the rest of the still image, which has not been selected, as a still image.

According to various, but not necessarily all, embodiments there is provided a computer program comprising computer program instructions that, when executed by at least one processor, enable an apparatus at least to perform: displaying a still image on a display; detecting user selection of a portion of the still image; and in response to the detection of the user selection, replacing the selected portion of the still image with a moving image and maintaining the rest of the still image, which has not been selected, as a still image.

In some embodiments there is also provided a computer program comprising program instructions for causing a computer to perform the method described above.

In some embodiments there is also provided a non-transitory entity embodying the computer program as described above.

In some embodiments there is also provided an electromagnetic carrier signal carrying the computer program as described above.

According to various, but not necessarily all, embodiments there is provided a user interface comprising: a display wherein the display is configured to; display a still image; and enable user selection of a portion of the still image such that in response to the detection of the user selection the selected portion of the still image is replaced with a moving image and the rest of the still image, which has not been selected, is maintained as a still image.

In some embodiments the moving images may be displayed within the still image so that there is no discontinuity between the boundary of the moving images and the boundary of the still image.

The apparatus may be for wireless communication.

### BRIEF DESCRIPTION

For a better understanding of various examples of embodiments of the disclosure reference will now be made by way of example only to the accompanying drawings in which:

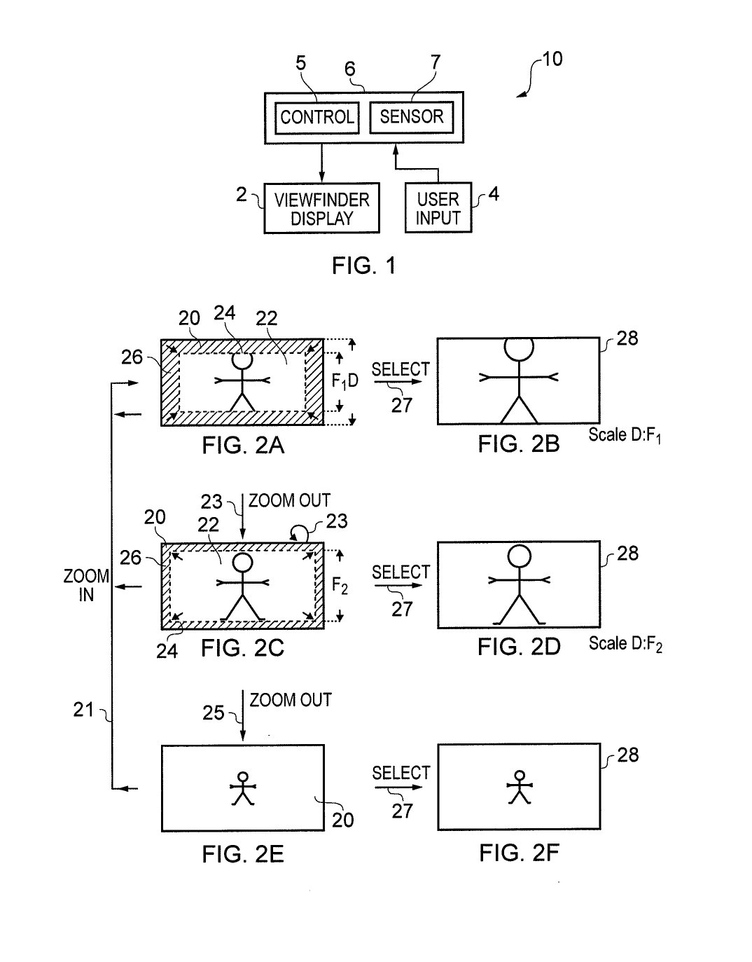

FIG. 1 schematically illustrates an apparatus according to an examplary embodiment of the disclosure;

FIG. 2 schematically illustrates an apparatus according to another examplary embodiment of the disclosure;

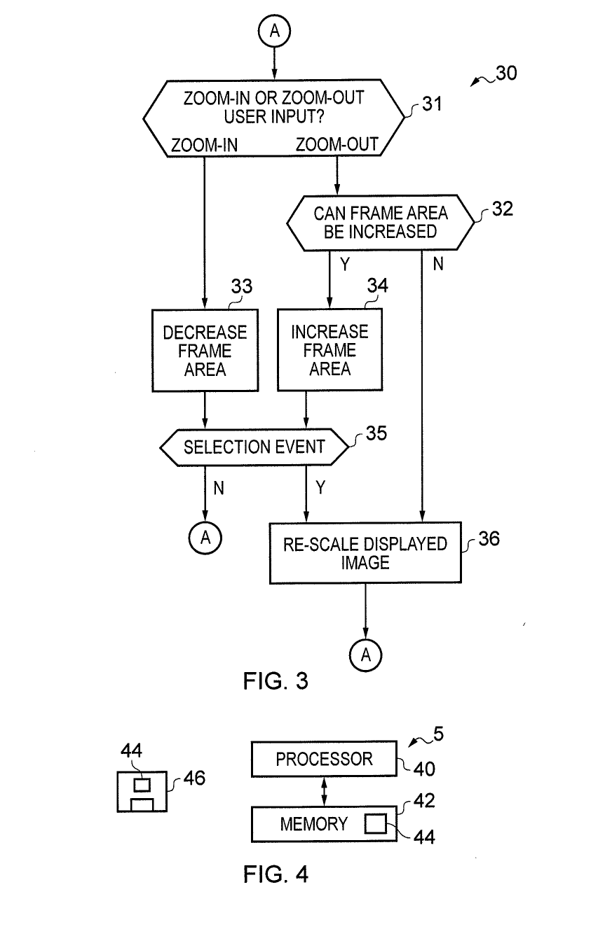

FIG. 3 is a block diagram which schematically illustrates methods according to an examplary embodiment of the disclosure;

FIGS. 4A to 4D illustrate graphical user interfaces according to an examplary embodiment of the disclosure;

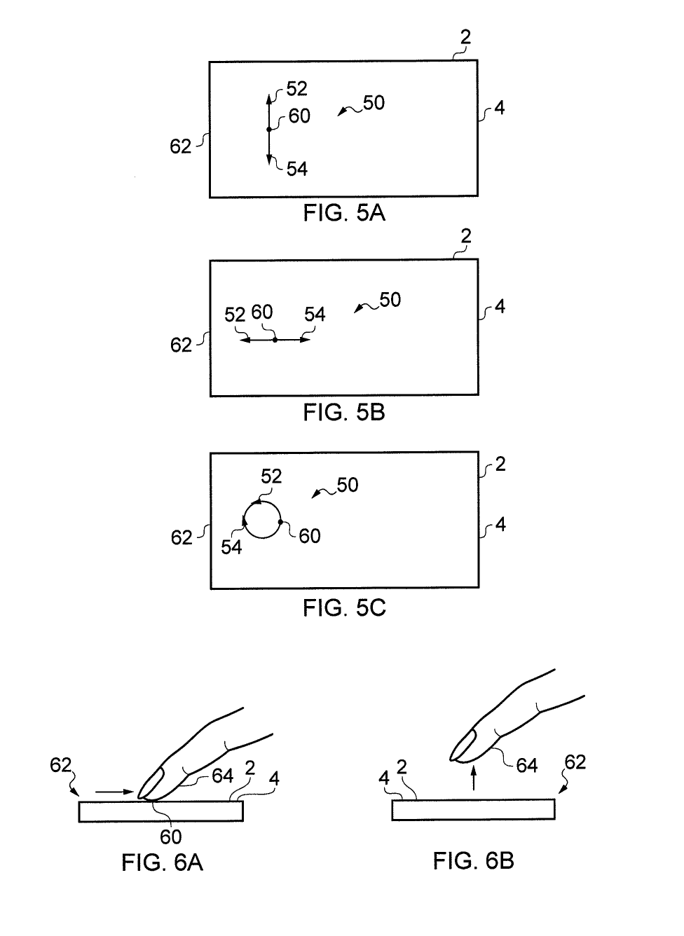

FIGS. 5A to 5F illustrate graphical user interfaces according to another examplary embodiment of the disclosure:

FIG. 6 illustrates a time line of capturing images according to an examplary embodiment of the disclosure; and

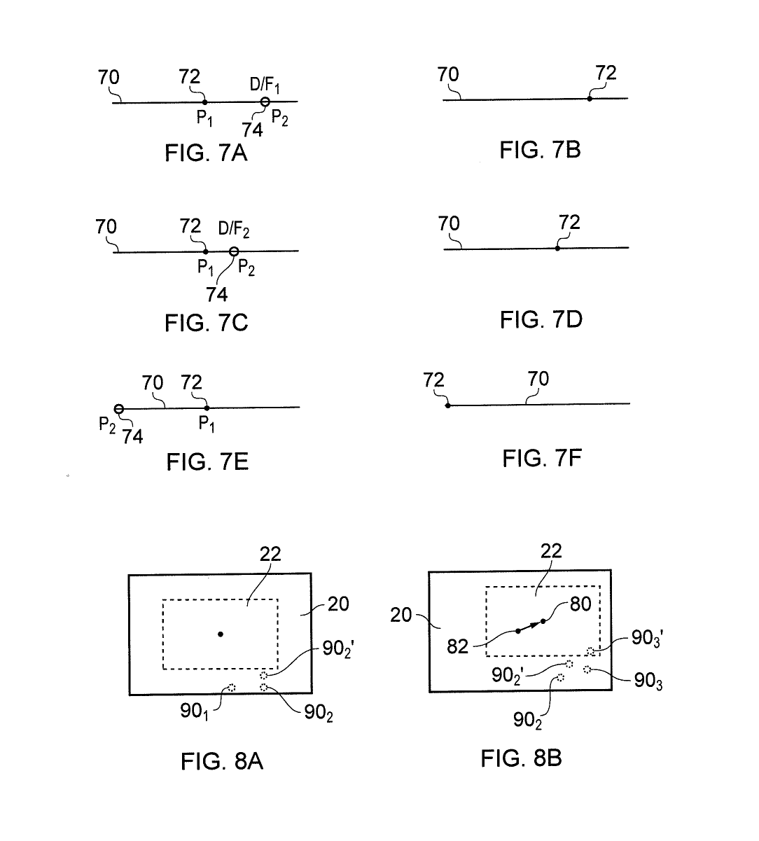

FIGS. 7A and 7B schematically illustrate an automatic analysis of captured images to create motion and non-motion portions.

### DETAILED DESCRIPTION

The Figures illustrate a method, apparatus 1, computer program 9 and user interface where the method comprises displaying 31 a still image 43 on a display 15; detecting 33 user selection of a portion 45, 47 of the still image 43; and in response to the detection 33 of the user selection, replacing 35 the selected portion 45, 47 of the still image 43 with a moving image 63, 65 and maintaining the rest of the still image 43, which has not been selected, as a still image 43.

FIG. 1 schematically illustrates an apparatus 1 according to an embodiment of the disclosure. The apparatus 1 may be an electronic apparatus. The apparatus 1 may be, for example, a mobile cellular telephone, a camera, a tablet computer, a personal computer, a gaming device, a personal digital assistant or any other apparatus which may enable a images to be displayed to a user. The apparatus 1 may be a handheld apparatus 1 which can be carried in a user's hand, handbag or jacket pocket for example.

Features referred to in the following description are illustrated in FIGS. 1 and 2. However, it should be understood that the apparatus 1 may comprise additional features that are not illustrated. For example, in embodiments where the apparatus 1 is configured for wireless communication the apparatus 1 may comprise one or more transmitters and receivers. Similarly in embodiments where the apparatus 1 comprises a camera the apparatus 1 may comprise one or more means for capturing and storing images.

The apparatus 1 illustrated in FIG. 1 comprises: a user interface 13 and a controller 4. In the illustrated embodiment the controller 4 comprises at least one processor 3 and at least one memory 5 and the user interface 13 comprises a display 15 and a user input device 17.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc.) to be executed by such processors 3.

The controller 4 may be configured to control the apparatus 1 to perform functions. A person skilled in the art would appreciate that the apparatus 1 may be used for any number and range of functions and applications. The functions may comprise, for example, capturing images or enabling a user to create images and causing images to be displayed on the display 15.

The controller 4 may also be configured to enable the apparatus 1 to perform a method comprising: displaying 31 a still image 43 on a display 15; detecting 33 user selection of a portion 45, 47 of the still image 43; and in response to the detection 33 of the user selection, replacing 35 the selected portion 45, 47 of the still image 43 with a moving image 63, 65 and maintaining the rest of the still image 43, which has not been selected, as a still image 43.

The at least one processor 3 is also configured to receive input commands from the user interface 13 and also to provide output commands to the user interface 13. The at least one processor 3 is also configured to write to and read from the at least one memory 5. Outputs of the user interface 13 may be provided as inputs to the controller 4.

The user input device 17 provides means for enabling a user of the apparatus 1 to input information. The user input device 17 may comprise any means which enables a user to control the apparatus 1 or input information into the apparatus 1. For example the user input device 17 may comprise a touch sensitive display 15 or a portion of a touch sensitive display 15, a key pad, an accelerometer or other means configured to detect orientation and/or movement of the apparatus 1, audio input means which enable an audio input signal to be detected and converted into a control signal for the controller 4 or a combination of different types of user input devices.

The display 15 may comprise any means which enables information to be displayed to a user of the apparatus 1. The information which is displayed may comprise information which has been input by the user via the user input device 17, information which is stored in the one or more memories 5, or information which has been received or downloaded by the apparatus 1 or any other suitable information or combination of information.

The information which is displayed on the display 15 may comprise an image or a plurality of images. The images may comprise still images which are static or non-moving so that the image displayed on the display 15 does not change over time. The images may also comprise moving images which are configured so that the image displayed on the display 15 changes over time without user input or further interrupts. In some embodiments of the disclosure the apparatus 1 may be configured to enable both still and moving images to be displayed on the display simultaneously. In some examplary embodiments of the disclosure a single image may comprise both still and moving portions.

In some embodiments the display 15 may comprise a touch sensitive display 15. The touch sensitive display 15 may be actuated by a user contacting the surface of the touch sensitive display 15 with an object such as their finger or other part of their hand or a stylus. A user may contact the surface of the touch sensitive display 15 by physically touching the surface of the touch sensitive display 15 with an object or by hovering or bringing the object close enough to the surface to activate the sensors of the touch sensitive display 15. The touch sensitive display 15 may comprises a capacitive touch sensitive display, or a resistive touch sensitive display 15 or any other suitable means for detecting a touch input or a hovering input.

The display 15 may be configured to display graphical user interfaces 41 as illustrated in FIGS. 4A to 4D and 5A to 5F.

The at least one memory 5 is configured to store a computer program 9 comprising computer program instructions 11 that control the operation of the apparatus 1 when loaded into the at least one processor 3. The computer program instructions 11 provide the logic and routines that enable the apparatus 1 to perform the examplary methods illustrated in FIG. 3.

The at least one memory 5 may also be configured to store images. The images may comprise still images or moving images. The images may be created by the apparatus 1 or received or downloaded by the apparatus 1 and stored in the at least one memory 5.

The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for displaying 31 a still image 43 on a display 15; detecting 33 user selection of a portion 45, 47 of the still image 43; and in response to the detection 33 of the user selection, replacing 35 the selected portion 45, 47 of the still image 43 with a moving image 63, 65 and maintaining the rest of the still image 43, which has not been selected, as a still image 43.

The computer program 9 may arrive at the apparatus 1 via any suitable delivery mechanism 21. The delivery mechanism 21 may comprise, for example, a computer-readable storage medium, a computer program product 23, a memory device, a record medium such as a CD-ROM or DVD, an article of manufacture that tangibly embodies the computer program 9. The delivery mechanism may be a signal configured to reliably transfer the computer program 9. The apparatus 1 may propagate or transmit the computer program 9 as a computer data signal.

The memory 5 may comprise a single component or it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the disclosure. The apparatus 1′ illustrated in FIG. 2 may be a chip or a chip-set. The apparatus 1′ comprises at least one processor 3 and at least one memory 5 as described above in relation to FIG. 1.

FIG. 3 is a block diagram which schematically illustrates methods according to an examplary embodiment of the disclosure. The method of FIG. 3 may be performed by an apparatus such as the apparatus 1 illustrated in FIGS. 1 and 2.

At block 31 the controller 4 of the apparatus 1 causes a still image 43 to be displayed on a display 15. The still image 43 may comprise an image which has been created by the apparatus 1. For example, in some embodiments the apparatus 1 may comprise a camera or other image capturing means which may enable images to be captured and stored in the at least one memory 5. In other embodiments of the disclosure the still image 43 may comprise an image which has been received by the apparatus 1.

The still image 43 may comprise any static or non-moving image. The still image 43 may be fixed so that it does not change over time. In some embodiments the still image 43 does not change without any input being made via the user input device 17 or other control signal being detected by the controller 4.

In some embodiments of the disclosure the still image 43 may comprise a photograph. It is to be appreciated that in other embodiments other types of images could be used. For example the image may comprise a drawing or graphics which have been created by a user of the apparatus 1, for example by using the user input device 17. The image may comprise a graphical representation of real world objects.

In some embodiments of the disclosure the still image 43 may be the only image displayed on the display 15. The still image 43 may be scaled so that the image occupies the maximum area of the display 15 available. In other embodiments of the disclosure a plurality of different images may be displayed on the display 15 simultaneously.

The still image 43 may be divided into a plurality of distinct portions. The plurality of distinct portions may comprise motion portions and non-motion portions. The controller 4 may be configured to automatically divide the still image 43 into motion and non-motion portions. In some embodiments the method illustrated in FIGS. 6 and 7 and described below may be used to divide the still image 43 into motion and non-motion portions.

A motion portion may comprise a portion of the still image 43 which has a sequence of moving images associated with it. The sequence of moving images may be associated with the portion of the still image 43 such that, in response to an appropriate user input the portion of the still image 43 is replaced with the sequence of moving images 63, 65. The moving images 63, 65 may be stored in the at least one memory 5 so that they can be retrieved in response to the appropriate user input. A non-motion portion of the still image may comprise a portion of the still image 43 which does not have a sequence of moving images 63, 65 associated with it.

In some embodiments of the disclosure the motion and non-motion portions may be displayed as a single continuous still image 43 without any boundaries or demarcation between the respective motion and non-motion portions. This may provide a high quality image to the user of the apparatus 1. The user of the apparatus 1 might not be able to distinguish between the motion and non-motion portions just by viewing the still image 43 displayed on the display 15.

At block 33 the controller 4 detects a user input. The user input comprises user selection of a portion 45, 47 of the still image 43. A user may select a portion of the still image 43 by selecting the area of the display 15 in which the respective portion 45, 47 is displayed. In embodiments of the disclosure where the display 15 comprises a touch sensitive display 15 the user may select a portion 45, 47 of the still image 43 by actuating the area of the display 15 in which the portion 45, 47 of the still image 43 is displayed. It is to be appreciated that other user inputs could be used in other embodiments.

In response to the detection 33 of the user input the controller 4 will determine whether or not the selected portion 45, 47 comprises a motion portion or a non-motion portion.

If the controller 4 determines that the user has selected a motion portion then, at block 35, the controller 4 controls the apparatus 1 to replace the selected portion 45, 47 of the still image 43 with moving images 63, 65 but maintain the rest of the still image 43 which has not been selected as a still image 43.

The moving images 63, 65 may comprise a video or sequence of images displayed in succession so that the images displayed on the display 15 appear to be moving. In embodiments where the still image 43 comprises a photograph the moving images 63, 65 may comprise a plurality of photographs. The plurality of photographs may have been captured in temporal proximity to the still image 43. The moving images may depict the movement or changes of the representation of objects which were initially represented in the initial still image 43.

The controller 4 may control the display 15 so that when the moving images 63, 65 replace the selected portion of the still image 43 the moving images 63, 65 are displayed in the area of the display 15 in which the selected portion 45, 47 of the still image 43 was previously displayed. The non-selected portions of the still image 43 may be maintained on the display 15 so that no change is made to the non-selected portions of the still image 43. The non-selected portions of the still image 43 may be displayed on the display 15 in the same area as they were displayed before the user input was detected.

The moving images 63, 65 may be displayed with no discontinuity between the moving images 63, 65 and the non-selected portion of the still images 43. This may enable the moving images 63, 65 to appear to be located within the still image 43.

If the controller 4 determines that the user has selected a non-motion portion then the controller 4 does not cause any changes to be made to the still image 43. The still image 43 displayed on the display 15 remains on the display 15 and no portions of the still image 43 are replaced with moving images 63, 65.

The respective motion and non-motion portions may be located anywhere within the still image 43. The location of the motion and non-motion portions may be determined by the controller 4 and may be dependent upon the content of the still image 43 and the moving images 63, 65. Different images may have the motion and non-motion portions of different shapes, sizes and locations.

In some embodiments of the disclosure the still image 43 may comprise more than one motion portion. The plurality of motion portions may be associated with different moving images 63, 65 so that selecting different motion portions causes different moving images 63, 65 to be displayed on the display 15.

In some embodiments where the still image 43 comprises a plurality of motion portions the apparatus 1 may be configured to enable the user to select a plurality of the motion portions simultaneously. This may enable a plurality of different sequences of moving images 63, 65 to be displayed simultaneously.

FIGS. 4A to 4D illustrate graphical user interfaces 41 according to an examplary embodiment of the disclosure. The graphical user interfaces 41 may be displayed on the display 15 of an apparatus 1 such as the apparatus 1 illustrated in FIG. 1. In this examplary embodiment the display 15 comprises a touch sensitive display 15.

The graphical user interface 41 illustrated in FIG. 4A comprises a still image 43. In this particular embodiment the still image 43 is a picture. The picture may be a photograph which has been captured using an image capturing means or a picture which has been drawn or otherwise created by a user of an apparatus 1.

In FIG. 4A the still image is static that is, without any further user input or interrupt detected by the apparatus 1 there is no movement or change of the image 43 displayed on the display 15.

In the example in FIG. 4A the still image 43 comprises a first portion 45 which depicts two people 51 seated on a bench 53 and a second, different portion 47 which depicts a child 55 holding a ball 57.

In the example in FIG. 4A the respective portions of the still image 43 are displayed without any deliberate discontinuity or boundary. In embodiments of the disclosure a user might not be able to distinguish between the respective portions simply by viewing the still image 43. However the controller 4 may be configured to distinguish between the respective portions of the still image 43 so that the controller 4 may provide different responses when different portions of the still image 43 are selected.

In FIG. 4B the user selects the first portion 45 of the still image 43 in which the two people 51 seated on the bench 53 is depicted. In the particular example of FIG. 4B the user selects the first portion 45 by actuating the area of the display 15 in which the first portion 45 is displayed. The user may actuate the area of the display 15 by touching the surface of the display 15 with a part of their hand 61 or by bringing their hand 61 in close proximity to the surface of the display 15.

In response to the detection of the user selection of the first portion 45 of the still image 43 the controller 4 determines that the selected portion 45 of the still image 43 comprises a motion portion and causes the selected portion 45 of the still image 43 to be replaced with moving images 63. The rest of the still image 43 which has not been selected is maintained so that no change is made to the portions of the still image 43 which have not been selected.

FIGS. 4C and 4D illustrate the moving images 63. In the embodiment of FIG. 4 the moving images 63 are displayed on the display 15 in the area where the selected portion 45 was originally displayed 15. The rest of the still image 43 which has not been selected remains unchanged and so the added moving images 63 appear to be positioned within the still image 43.

In FIG. 4C the two people 51 seated on the bench 53 have moved closer together and in FIG. 4D the two people 51 seated on the bench 53 kiss each other. There is no movement or change of the rest of the still image 43 between FIGS. 4B, 4C and 4D. In particular the second portion 47 in which the child 55 holding a ball 57 is depicted does not change. There is no movement or change of the child 55 holding the ball 57.

FIGS. 5A to 5F illustrate graphical user interfaces 41 according to another examplary embodiment of the disclosure. The graphical user interface 41 illustrated in FIG. 5A comprises the same still image 43 illustrated in FIG. 4A. The still image 43 comprises the first portion 45 which depicts two people 51 seated on a bench 53 and the second, different portion 47 which depicts a child 55 holding a ball 57.

In FIG. 5A the user selects the second, different portion 47 of the still image 43 in which the child 55 holding a ball 57 is depicted. As in the example described above the user selects the second, different portion 47 by actuating the area of the display 15 in which the second, different portion 47 is displayed. The user may actuate the area of the display 15 by touching the surface of the display 15 with a part of their hand 61 or by bringing their hand 61 in close proximity to the surface of the display 15.

In response to the detection of the user selection of the second, different portion 47 of the still image 43 the controller 4 determines that the selected portion 47 of the still image 43 also comprises a motion portion and causes the selected portion 47 of the still image 43 to be replaced with moving images 65. The rest of the still image 43, including the first portion 45, which has not been selected is maintained so that no change is made to the portions of the still image 43 which have not been selected.

FIGS. 5A to 5F illustrate the moving images 65 which are provided on the display 15 in response to the selection of the second, different portion 47. In the embodiment of FIG. 5 the moving images 65 are displayed on the display 15 in the area where the selected portion 47 was originally displayed 15. The rest of the still image 43 which has not been selected remains unchanged and so the added moving images 65 appear to be positioned within the still image 43.

In FIG. 5A the child 55 is depicted holding a ball 57. In FIG. 5B the child 55 kicks the ball 57. In FIG. 5C the ball 57 is moving towards a lamppost. In FIG. 5D the ball 57 hits the lamppost and reverses direction of motion. In FIG. 5E the ball 57 is shown moving back towards the child 55 and in FIG. 5F the ball 57 collides with the head of the child 55 and causes the child 55 to fall over.

There is no movement or change of the rest of the still image 43 between FIGS. 5A to 5F. In particular the first portion 45 in which the two people 51 seated on the bench 53 is depicted does not change. There is no movement or change of the two people 51 seated on the bench 53.

It is to be appreciated that in FIGS. 4 and 5 the sequence of moving images 63, 65 may be played once or they may be played cyclically until a further user input or other control signal is detected by the controller 4.

In the examplary embodiments of FIGS. 4 and 5 there are no boundaries or deliberate discontinuities between the moving images 63, 65 and the rest of the still image 43. This may enable the moving images 63, 64 to be displayed in context so that they appear to be a located within the still image 43.

In the examples of FIGS. 4 and 5 the two different portions are selected separately so that only one set of moving images 63, 65 is displayed at any one time. In other embodiments of the disclosure the user may be able to select both the first portion 45 and the second, different portion 47 simultaneously so that the two different sets of moving images 53, 65 may be displayed simultaneously.

In the examples of FIGS. 4 and 5 only three and six different images respectively are illustrated to indicate the moving portions. It is to be appreciated that there may be intermediate images or other images in the sequence that have not been illustrated for conciseness.

FIGS. 6 and 7 illustrate an examplary method which may be used to create images for use with embodiments of the disclosure. It is to be appreciated that other methods could be used.

FIG. 6 illustrates a time line 71 of capturing images according to an examplary embodiment of the disclosure. The images may be photographs or any other suitable image which may be captured or otherwise created by the apparatus 1.

At a first time t₁ a first image is captured. The first image may be a still image 43. The first image 43 may be the image which is displayed on the display in FIGS. 4A and 5A and in other embodiments before a user input is detected.

Between times t₂ and t₃ a plurality of further images are captured. The further captured images may be used to create the moving images 63, 65 for the embodiments of the disclosure.

The plurality of further images may be captured at regular time intervals between times t₂ and t₃. The time interval between capturing the further images may be very short, for example it may be of the order of 0.1 or 0.01 of a second. Any number of images may be captured between times t₂ and t₃. In some embodiments the number of images captured may be of the order of twenty. The further images which are captured may be such that if they are displayed on a display 15 in quick succession the objects represented in the images may appear to be moving or changing.

The time period of t₂ to t₃ may occur after a small period of time has elapsed since t₁. The small period of time may be of the order of 0.1 or 0.01 of a second. This may enable the images which become the moving images 53, 65 to be captured in temporal proximity to the still image 43.

In the example in FIG. 6 the further images are captured after the first image has been captured. That is, in the time line of FIG. 6, t₁ occurs before t₂ and t₃. In other embodiments of the disclosure t₁ could occur after t₂ and t₃ or even between t₂ and t₃.

FIGS. 7A and 7B schematically illustrate an automatic analysis of captured images to create motion and non-motion portions. The method of FIGS. 7A and 7B may be performed by the controller 4. FIG. 7A illustrates four sequential images 71A, 71B, 71C and 71D which have been captured between t₂ and t₃. It is to be appreciated that other images may also have been captured but these are not illustrated for conciseness.

The controller 4 divides the images 71A, 71B, 71C and 71D into smaller regions or micro-blocks. Each region or micro-block represents a small area of the captured image 71A, 71B, 71C and 71D. For each captured image 71A, 71B, 71C and 71D the controller 4 analyses each of the micro blocks and compares it to a micro block in the same or similar position in the other captured images. The controller will then determine if a change has taken place between the images in each of the micro blocks. Any suitable method or algorithm may be used to analyse and compare the micro blocks, for example, in some embodiments pattern recognition may be used.

In FIG. 7A the controller 4 has determined which of the micro blocks have differences compared to the equivalent micro blocks of the adjacent images. These are indicated by the demarcated areas 73 within the captured images 71A, 71B, 71C and 71D.

In FIG. 7B the controller 4 superimposes the images captured images 71A, 71B, 71C and 71D to compare the positions of the demarcated areas 73. The relative positions of the demarcated areas 73 are then combined to determine motion portions 75A, 75B and 75C and non-motion portions of the original still image 43. The motion portions 75A, 75B and 75C correspond to regions of the images 71A, 71B, 71C and 71D where the demarcated areas 73 indicate that there is a change in the image between some of the captured images 71A, 71B, 71C and 71D. The non-motion portions 77 comprise the rest of the image which are not associated with any change and do not have any demarcated areas 73 associated with it.

The motion portions 75A, 75B and 75C may be associated with the respective sections of the captured images so that when a user selects the respective portion the captured images are displayed sequentially on the display 15.

In some embodiments of the disclosure only the sections of the captured images which are determined to have a change or motion depicted within it may be saved in the at least one memory 5. The rest of the captured images which do not have any change or motion detected with them may be discarded as they will not be needed to replace a portion of the still image 43 on the display. This may save the amount of memory 5 needed to store the images.

Embodiments of the disclosure provide an improved and interactive way of enabling user to view images. The user interface provides a simple and intuitive way of enabling a user to control the images as they are displayed on the display but still enables high quality images to be presented to a user.

The blocks illustrated in the FIG. 3 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

Although embodiments of the present disclosure have been described in the preceding paragraphs with reference to various examples, it should be appreciated that modifications to the examples given can be made without departing from the scope of the disclosure as claimed. For example, in the examplary embodiments described above a touch screen display 15 is used. It is to be appreciated that in other embodiments other different types of display could be used instead. In other embodiments, the display may comprise, a projected display, for example. In such embodiments other types of user input may also be used, for example motion of the user or parts of the body of the user may be detected to provide the user input. The motion of the user or part of the user's body may be detected using any suitable method such as a camera or other motion sensor. The motion of the user's body may imitate a user touching a touch sensitive display, for example, it may comprise a user touching or pointing in the general direction of a portion of the projected display.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
displaying a still image on a display;
detecting user selection of a portion of the still image; and
in response to the detection of the user selection, replacing the selected portion of the still image with a moving image and maintaining the rest of the still image, which has not been selected, as a still image.

2. A method as claimed in claim 1 wherein the moving images are displayed within the still image so that there is no discontinuity between the boundary of the moving images and the boundary of the still image.

3. A method as claimed in claim 1 wherein the moving images are located within any portion of the still image

4. A method as claimed in claim 1 wherein the still image comprises motion portions and non-motion portions such that in response to the detection of user selection of a motion portion the selected motion portion is replaced with a moving portion and in response to the detection of user selection of a non-motion portion the whole of the still image is maintained as a still image.

5. A method as claimed in claim 1 further comprising in response to the detection of user selection of a second portion of the still image, replacing the second selected portion of the still image with a second moving image and maintaining the rest of the still image, which has not been selected, as a still image.

6. A method as claimed in claim 5 wherein the first portion and the second portion may be selected simultaneously so that a plurality of selected portions of the still image may be replaced with moving images simultaneously.

7. A method as claimed in claim 1 wherein the still image is one of a plurality of images displayed simultaneously on the display.

8. A method as claimed in claim 1 wherein maintaining the non-selected portion of the still image as a still image comprises making no change to the non-selected portion of the still image.

9. A method as claimed in claim 1 wherein the still image comprises a photograph.

10. A method as claimed in claim 9 wherein the moving images comprise portions of a plurality of photographs captured in temporal proximity to the still image.

11. A method as claimed in claim 1 wherein a portion of the still image is selected by actuating the area of the display in which the portion of the still image is displayed.

12. An apparatus comprising:
at least one processor; and
at least one memory including computer program code;
wherein the at least one memory and the computer program code are configured to, with the at least one processor, enable the apparatus to:
display a still image on a display;
detect user selection of a portion of the still image; and
in response to the detection of the user selection, replace the selected portion of the still image with a moving image and maintain the rest of the still image, which has not been selected, as a still image.

13. An apparatus as claimed in claim 12 wherein the moving images are displayed within the still image so that there is no discontinuity between the boundary of the moving images and the boundary of the still image.

14. An apparatus as claimed in claim 12 wherein the moving images are located within any portion of the still image.

15. An apparatus as claimed in claim 12 wherein the image comprises motion portions and non-motion portions such that in response to the detection of user selection of a motion portion the at least one memory and the computer program code are configured to, with the at least one processor, enable the apparatus to replace the selected motion portion with a moving portion and in response to the detection of user selection of a non-motion portion maintain the whole still image as a still image.

16. An apparatus as claimed in claim 12 wherein the at least one memory and the computer program code are configured to, with the at least one processor, enable the apparatus to detect user selection of a second portion of the still image and in response to the detection of user selection of the second portion of the still image, replace the second selected portion of the still image with a second moving still image and maintain the rest of the still image, which has not been selected, as a still image.

17. An apparatus as claimed in claim 16 wherein the first portion and the second portion are configured so that they may be selected simultaneously so that a plurality of selected portions of the still image are replaced with moving portions simultaneously.

18-20. (canceled)

21. An apparatus as claimed in claim 12 wherein the moving images comprise portions of a plurality of photographs captured in temporal proximity to the still image.

22. An apparatus as claimed in claim 12 wherein a portion of the image is selected by actuating the area of the display in which the portion of the image is displayed.

23. A non-transitory entity embodying a computer program comprising computer program instructions that, when executed by at least one processor, enable an apparatus at least to perform:
displaying a still image on a display;
detecting user selection of a portion of the still image; and
in response to the detection of the user selection, replacing the selected portion of the still image with a moving image and maintaining the rest of the still image, which has not been selected, as a still image.

24-28. (canceled)
